(19) United States
(12) Patent Application Publication
(10) Pub. No.: US 2023/0192250 A1
(43) Pub. Date: Jun. 22, 2023

(54) MARINE FENDER AND METHOD FOR TRANSFERRING A BODY BETWEEN A VESSEL AND AN OFFSHORE STRUCTURE

(71) Applicant: ØRSTED WIND POWER A/S, Fredericia (DK)

(72) Inventors: Peter Teglman SCHIØLER, Gentofte (DK); Mikkel Haugaard WINDOLF, Gentofte (DK)

(21) Appl. No.: 18/081,520

(22) Filed: Dec. 14, 2022

(30) Foreign Application Priority Data
Dec. 17, 2021 (EP) 21-215701

(51) Int. Cl. B63B 59/02

(52) U.S. Cl. CPC B63B 59/02

(57) ABSTRACT

Marine fender (1) for engaging an offshore structure (10) during a transfer operation. The fender (1) comprises a mount (3) for fixing the fender (1) to a vessel (5). An engagement part (2) engages with an opposing surface (11) of the offshore structure (10) when the vessel (5) and opposing surface are forced together such that interface friction resists movement of the engagement part (1) over the opposing surface (11). A coupling (4) is provided connecting the engagement part (2) to the mount (3), wherein the coupling (4) comprises a regulating part for regulating the velocity of movement of the engagement part (2) over the opposing surface (11).

The present invention concerns a marine fender and a marine transfer method for transferring a body between a vessel and an offshore structure. The disclosure particularly concerns a marine transfer apparatus and method for use with a monopile offshore structure, such as a wind turbine generator having a monopile foundation. The disclosure is particularly relevant to a marine bumper for use when transferring a person between a crew transfer vessel and an offshore structure.

Transferring a body, such as a person or an object, between a marine vessel, such as a boat, and a fixed offshore structure can be a challenging and hazardous process. Waves in the water, caused by wind or swell, apply forces on the vessel, moving its position relative to the offshore structure. In particular, as waves pass through, movements of the vessel can be complex and difficult to predict because the vessel may be simultaneously subjected to both rotational motions, such as pitch, roll and yaw, as well as translational motions, such as heave, sway and surge. In some circumstances it may be possible to minimise motions such as roll, yaw, sway and surge by forcing the vessel and the structure together, for instance by driving the vessel into an offshore structure's boat landing using the vessel's propulsion system. This causes the vessel to push onto the foundation, thereby creating friction between the bow and the structure. The frictional engagement may also be improved by incorporating a non-slip fender on the vessel's bow, which also helps to prevent damage to the bow and the structure itself by absorbing kinetic energy. However, vertical motions are nevertheless difficult to mitigate. For example, in small wave conditions, the bow may be kept in permanent engagement with the structure, but as the waves become bigger, there is a risk of a sudden slippage if the water level drops away from the vessel or it rapidly surges upwards. This risks rapid drops and upward rises of the vessel as the surfaces slide across each other. This makes such transfer operations especially hazardous because there is a risk that the crew member transferring could get caught between the vessel and the structure when they are attempting to transition from the vessel onto, for example, a static ladder provided on the exterior of the offshore structure.

To mitigate the above risks, it will often be the decision of the skipper or other responsible crew member to identify periods where safe personnel transfer can be effected. To aid this, some modern vessels incorporate wave detection systems linked to a traffic light-type indicator for identifying periods were crew may safely transfer. Nevertheless, periods where transfer can safely occur can be extremely short, with this meaning that transfer operations may not be able to take place because they are too dangerous to the personnel transferring.

Various alternative transfer methods have also been used. For example, helicopters can be used in some circumstances, and other solutions involve the use of motion compensated gangways between the vessel and a platform. However, such methods are expensive and are typically only possible with larger structures and using larger vessels. As such, these methods are rarely suitable for use with offshore wind turbine structures, where the monopile foundations are typically smaller, and have smaller boat landings and maintenance platforms. Furthermore, because monopile foundation structures are unmanned, it is much more difficult to implement systems which rely on active personnel on the platform.

Accordingly, there is a need for an improved marine transfer apparatus and method to facilitate safer transfer operations.

The present invention therefore seeks to address the above issues.

According to a first aspect of the present invention, there is provided a marine fender for engaging an offshore structure during a transfer operation, the fender comprising: a mount for fixing the fender to a vessel; an engagement part for engaging with an opposing surface of the offshore structure when the vessel and opposing surface are forced together such that interface friction resists movement of the engagement part over the opposing surface; and a coupling connecting the engagement part to the mount, wherein the coupling comprises a regulating part for regulating the velocity of movement of the engagement part over the opposing surface.

In this way, once the fender has engaged the outer surface of the offshore structure, such as a wind turbine monopile, the movements of the vessel relative to the structure may be moderated by regulating the movement of the engagement part over the opposing surface. As such, rapid changes in the position of the vessel, such as a ship, may be restrained. For example, as the hull passes through a wave trough, movement of the engagement part over the opposing surface may be controlled to slow the transition as the vessel drops to a lower position. Conversely, when a wave crest forces the vessel upwards, the transition to a higher position may be slowed. Accordingly, the length of time where a body may be safely transferred between the vessel and the structure is effectively extended. This is because the dramatic changes in vessel position, which may otherwise occur when the fender suddenly slips relative to the structure, are mitigated. As such, safer transfer operations may be conducted. Moreover, advantageously, because the marine fender may be fitted to the vessel, safer transfer operations may be facilitated without needing to adapt every offshore structure.

In embodiments, the regulating part is configured to regulate the vertical velocity of the engagement part over the opposing surface. In this way, sudden falls and rises of the vessel may be mitigated.

In embodiments, the regulating part comprises a damper. In this way, energy from the forces applied to the vessel may be dissipated through the damper to prevent rapid changes of position.

In embodiments, the damper comprises a viscous fluid damper or a computer regulated damper. In this way, in the case of a viscous fluid damper, a passive damper may be provided which does not require active control and hence improved reliability may be achieved. In other embodiments, an actively controllable damper may be provided. For example, the damper may include a variable resistance gear in which the movement resistance is adjusted depending on the forces applied to the fender. A controller may be used to implement an anti-lock braking protocol by regulating the movement resistance using the controllable damper. In such arrangements, the damper may be a computer regulated damper.

In embodiments, the regulating part is configured to moderate movement between the engagement part relative to the mount for damping forces applied through the vessel to the opposing surface. In this way, the engagement part is moveable relative to the mount such that forces delivered through the engagement part's interface with the structure can be minimised.

In embodiments, the regulating part is configured to limit the amplitude of forces applied through the vessel to the opposing surface.

In embodiments, the regulating part is configured for limiting the amplitude of forces applied through the vessel to the opposing surface to less than the static friction between the engagement part and the opposing surface during the transfer operation. In this way, once engaged, uncontrolled slippage between the engagement part and the opposing surface may be avoided by dissipating the applied forces through a controlled movement.

In embodiments, the engagement part comprises a roller, wherein the roller is rotatably connected to the mount by the coupling, and the regulating part regulates its rotational speed for regulating the velocity of movement of the engagement part over the opposing surface. In this way, movement of the fender may be regulated by controlling the speed of the roller. That is, the roller may have a rolling resistance which arrests rapid movements over the opposing surface.

In embodiments, the regulating part comprises a rotary damper. In this way, a simple regulator may be used to slow down the motions of the engagement part.

In embodiments, the engagement part further comprises a second roller, wherein the second roller is rotatably connected to the mount by the coupling, and the regulating part regulates its rotational speed for regulating the velocity of movement of the engagement part over the opposing surface. In this way, a larger surface area for engagement with an offshore structure may be provided.

In embodiments, the engagement part forms a concave engagement interface to the opposing surface. In this way, a larger surface area may be provided for engaging with an opposing curved surface of the structure. As such, a higher interface friction may be provided, thereby allowing a greater resistance to interface failure.

In embodiments, when the engagement part comprises first and second rollers, and the rollers are supported by the coupling in a concave V-configuration for engaging with a curved opposing surface. In this way, when the opposing surface has a curved profile, such as a monopile, it may be wedged between the rollers for gripping the exterior of the structure.

In embodiments, the engagement part is for engagement with a monopile foundation. In this way, the engagement part may be shaped for mating to an exterior surface of the monopile for facilitating transfer of crew from a vessel, such as a maintenance boat, to the structure supported by the monopile foundation. In embodiments, the engagement part may be for engagement with a wind turbine monopile foundation.

According to a second aspect, there is provided a method for transferring a body between a vessel and an offshore structure in a transfer operation, the method comprising the steps of: providing a marine fender for engaging the offshore structure during the transfer operation, the fender being fixed to the vessel by a mount: forcing the vessel and the structure together to engage an engagement part of the fender with an opposing surface of the offshore structure such that interface friction resists movement of the engagement part over the opposing surface; regulating the velocity of movement of the engagement part over the opposing surface using a regulating part of a coupling connecting the engagement part to the mount; and transferring the body between the vessel and the offshore structure. In this way, improved safety may be achieved during transfer operations by minimising rapid movements of the vessel and thereby extending the duration of periods within which safe transfer may be facilitated.

In embodiments, the step of regulating the velocity comprises limiting the amplitude of forces applied through the vessel to the opposing surface to less than the static friction between the engagement part and the opposing surface during the transfer operation.

According to a third aspect, there is provided a marine vessel, comprising: a mount; a fender fixed to the mount for engaging an offshore structure during a transfer operation, the fender comprising: an engagement part for engaging with an opposing surface of the offshore structure when the vessel and opposing surface are forced together such that interface friction resists movement of the engagement part over the opposing surface; and a coupling connecting the engagement part to the mount, wherein the coupling comprises a regulating part for regulating the velocity of movement of the engagement part over the opposing surface.

Illustrative embodiments of the present invention will now be described with reference to the accompanying drawings in which:

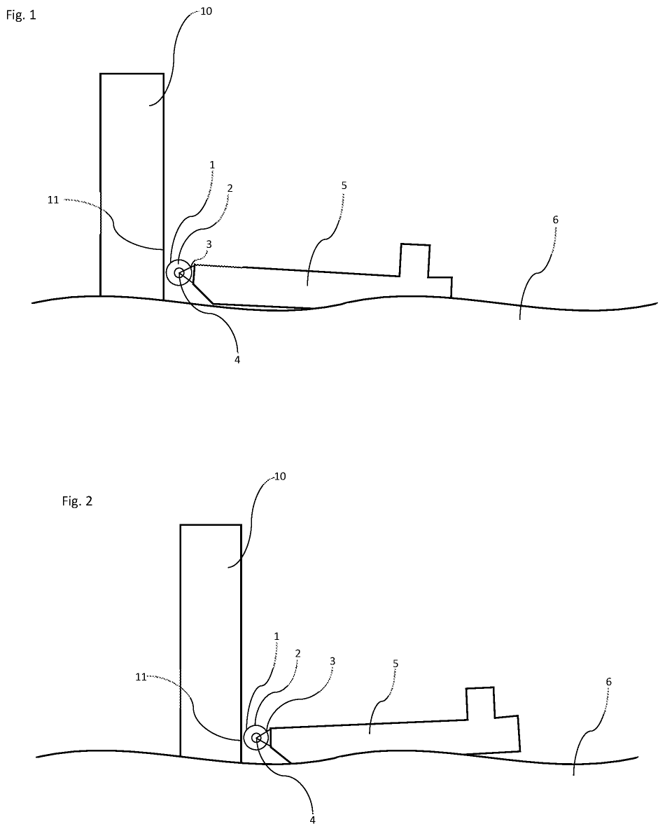

FIG. 1 shows a schematic side view of a marine fender according to a first embodiment during a wave crest;

FIG. 2 shows a schematic side view of a marine fender of the first embodiment during a wave trough;

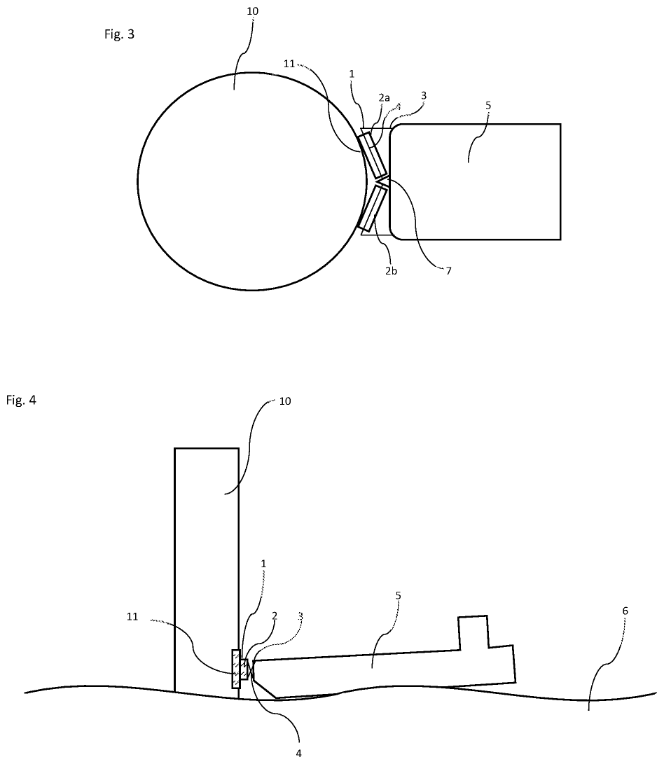

FIG. 3 shows a schematic top view of a marine fender according to a second embodiment; and

FIG. 4 shows a schematic side view of a marine fender according to a third embodiment.

FIG. 1 shows a first embodiment of a marine fender 1. In this embodiment, the fender 1 is configured for engagement with a wind turbine monopile 10 during a transfer operation in which crew is transferred between a boat 5 and so-called ‘secondary steel’, such as external ladders and platforms, provided on the monopile's exterior.

The fender 1 includes a frame 3 which is mounted at its rear to the bow of the boat 5. The front of the fender 1 comprises a roller 2 which forms an engagement part used to engage with the opposing surface 11 of the monopile 10. In this embodiment, the roller has a rubberised outer surface which forms a high friction interface when pressed against the monopile.

The roller 2 is held in a horizontal orientation and is connected to the frame 3 by a rotatable coupling 4. The coupling 4 comprises a horizontal axel which extends through the roller 2 and a rotary damper which restrains rotation of the roller about the axel. In this embodiment, the rotary damper is a viscous rotary damper, whereby rotation is resisted by the shearing of viscous fluid within the damper body. This thereby controls the speed of rotation of the roller 2. In other embodiments, other damper mechanisms may be used, such as spring dampers or computer regulated dampers. In the case of computer regulated damper arrangements, the resistance profile of the damper may be controlled, for example based on feedback from force sensor and/or a wave prediction system. This may allow the speed of rotation of the roller 2 to be varied throughout its movement to optimise the velocity control provided by the fender.

In use, the boat 5 and monopile 10 are forced together, for example by driving the boat 5 toward the monopile 10, such that roller 2 is forced into engagement with the opposing surface 11 of the monopile body 10. In other embodiments, other mechanisms may be used to force the vessel and structure together, such as a magnetic arrangement which draws the surfaces together. In any case, the engagement force establishes static friction at the interface between the surface area of the roller 2 in contact with the monopile 10. At the same time, the restraining action of the rotary damper resists rotation of the roller 2 such that it is not free to roll vertically up or down the opposing surface 11. As such, the boat 5 is effectively pinned at its bow to the exterior of the monopile 10 through the fender 1, with the forward drive force of the boat's propeller pressing the interface surfaces together.

As shown in FIG. 1, during a wave crest, the fender 1 may be pinned to the opposing surface 11 in a relatively high position. As waves 6 move past the monopile structure 10, wave troughs will cause the water level to move downward relative to the position of the boat 5. When the water level at the bow drops away, the downward force applied by gravity acts to drag the fender 1 downward. This downward force is initially resisted by the interface friction between the roller 2 and the opposing surface 11. However, rather than allow slippage to occur once the frictional resistance is overcome, the rotational damper provided in coupling 4 is configured to permit the roller 2 to roll down the monopile 10 in a controlled manner. As such, the boat 5 transitions slowly to a lower position, as shown in FIG. 2, with some of the potential energy from the vertical transition being dissipated through the rotary damper.

Conversely, when the boat's bow is pinned in a lower position, it may be driven upward by its buoyancy against the surge of a wave crest. This upward movement is resisted by the roller 2, with the roller 2 configured to roll slowly under the control of the coupling 4.

Accordingly, with the above arrangement, the risk of uncontrolled slippage between the fender 1 and the monopile 10 is mitigated. As such, rapid changes in the vertical position of the boat's bow may be avoided by damping movements caused by passing waves through the regulated movement of the roller 2. This thereby extends the time periods during which safe transfer of crew and other bodies between the boat 5 and monopile 10 may be achieved. Furthermore, although the horizontal roller 2 in this embodiment acts to regulate vertical movement, it will be understood that lateral and rotational forces applied through the interface are also resisted. Moreover, because slippage of the fender across the opposing surface is minimised, wear and other mechanical damage which might otherwise occur to the structure or its secondary steel is minimised.

In embodiments, the roller 2 may also be provided with a profile for more closely mating with the corresponding surface of the opposing structure. For instance, in the case of a monopile, the roller 2 may have a concave cylinder profile for mating with the curvature of the monopile body.

FIG. 3 shows a schematic top view of a marine fender according to a second embodiment. This embodiment operates in substantially the same way as the first embodiment, except that a second roller 2b is provided. In this respect, first and second rollers 2a,2b are supported in a V-configuration by the frame 3, to form a combined concave engagement area which can be wedged onto the curved opposing surface 11 of the monopile 10. In this embodiment, the coupling 4 comprises two axels for supporting the rollers 2a,2b, with the axels connected to a central rotary damper 7 which regulates the rotational speed of both rollers 2a,2b for thereby resisting rapid changes in position of the boat 5 during the transfer operation. The provision of the two rollers 2a,2b in an angled configuration provides greater resistance to lateral forces applied to the boat 5, as well as a larger contact surface area for regulating vertical movements. In other embodiments, it is also envisaged that more than two rollers may be provided. For example, three rollers 2 may be used to further increase the frictional engagement with the foundation 10.

FIG. 4 shows a schematic side view of a marine fender according to a third embodiment. This embodiment operates in a similar way to the first and second embodiments except that, rather than a roller, the engagement part is provided as an interface plate 2 which is moveably coupled to the mounting frame 3 by a coupling 4 comprising piston fluid viscous dampers. The coupling 4 allows the interface plate 2 to move vertically relative to the mounting frame 3 in a plane that is parallel to the vertical plane of the mounting. As such, the interface plate 2 can resistively shear vertically relative to its mounting. As such, the fender 1 effectively deforms in response to the forces applied to it. Consequently, upward or downward forces applied to the boat 5 are initially absorbed by the coupling 4, until it reaches the extremity of its moveable range. At this point, continued forces applied to the boat 5 may cause the interface place 2 to slip relative to the opposing surface 11. However, because the coupling 4 is able to regulate the initial movement of the boat before the interface friction is exceeded, an extended duration of time is provided where movement of the boat 5 is regulated, before slippage occurs.

Accordingly, as with other embodiments, the periods where the boat 5 moves in an uncontrolled manner are reduced, thereby minimising the occurrences of rapid changes in the vertical position of the boat's bow. Accordingly, a safer method of transferring crew and other bodies between a boat and an offshore structure, such as a monopile, may thereby be provided.

It will be understood that the embodiments illustrated above show applications of the invention only for the purposes of illustration. In practice the invention may be applied to many different configurations, the detailed embodiments being straightforward for those skilled in the art to implement.

In this connection, for example, it will be understood that embodiments of the invention may be used in conjunction with other safety mechanisms and systems. For instance, a wave detection system with an indicator may be used to alert crew members to periods where safe transfer from a vessel to a structure may be facilitated. Advantageously, arrangements according to the claimed invention may extend these time periods by resisting vessel movements when the vessel is subjected to smaller waves and slowing vessel movements when larger waves hit.

It will also be understood that, in embodiments, the offshore structure may be provided with an adapted surface as the opposing surface for engagement by the engagement part. For example, a high-friction coating may be provided to increase the interface friction with the engagement part.

It is also envisaged that embodiments may be provided where a controllable frictional interface between the engagement part and the opposing surface is provided. This may be achieved, for instance, by providing a fluid feed at the coupling for selectively lubricating the contact area between the engagement part and the opposing surface. This may be used independently with a fixed engagement plate or in combination with a mechanically moveable engagement part. In periods where the vertical transition between a wave crest and trough are larger, liquid may be applied to lubricate the interface for controlling the fender's movement across the surface of the structure. This may allow a consistent and predicable movement, rather than a sudden drop or rise. Conversely, in periods where the vertical transition between a wave crest and trough are smaller, friction may be increased by removing the lubricant, thereby providing a more stable position of the vessel.

In addition, it will be understood that although the above illustrative embodiments show engagement of the fender directly into a monopile, the fender may be configured for engagement with other parts of the offshore structure. For example, in embodiments, the engagement part of the fender may be profiled for engagement with a boat landing or with secondary steel structures.

Furthermore, it will be understood that although the above illustrative embodiments have been described in the context of transfer operations involving crew, embodiments may also be applied to transfer operations involving objects, such as components, parts, and structural elements. Such objects may also be heavy, and a crane, hoisting system, or conveyer provided on the vessel may be used to lift and transfer the objects between the vessel and the structure. In such scenarios, the effect of moving the weight relative to the vessel may change the overall centre of gravity, thereby applying forces to the vessel which act on it to move in the water. Embodiments of the invention may therefore equally be used to resist and regulate these movements during the object transfer operation.

Finally, it will also be understood that embodiments of the invention are also applicable to transfer operations between a vessel and a floating offshore structure, such as a floating wind turbine or platform. In such scenarios, both the vessel and the structure may move in the waves. However, because the vessel and the structure can have, for instance, different weights, shapes, different centres of gravity, different buoyancies, and be influenced by wind differently, they may move differently in the water. Nevertheless, embodiments of the invention may similarly be used to resist and regulate relative movements between the two engaged parts, thereby allowing safer object transfer operations between the vessel and the structure.

1. A marine fender for engaging an offshore structure during a transfer operation, the fender comprising:
a mount for fixing the fender to a vessel;
an engagement part for engaging with an opposing surface of the offshore structure when the vessel and opposing surface are forced together such that interface friction resists movement of the engagement part over the opposing surface; and
a coupling connecting the engagement part to the mount, wherein the coupling comprises a regulating part for regulating the velocity of movement of the engagement part over the opposing surface.

2. A fender according to claim 1, wherein the regulating part is configured to regulate the vertical velocity of the engagement part over the opposing surface.

3. A fender according to claim 1, wherein the regulating part comprises a damper.

4. A fender according to claim 3, wherein a damper comprises a viscous fluid damper or a computer regulated damper.

5. A fender according to claim 1, wherein the regulating part is configured to moderate movement between the engagement part relative to the mount for damping forces applied through the vessel to the opposing surface.

6. A fender according to claim 5, wherein the regulating part is configured to limit the amplitude of forces applied through the vessel to the opposing surface.

7. A fender according to claim 6, wherein the regulating part is configured for limiting the amplitude of forces applied through the vessel to the opposing surface to less than the static friction between the engagement part and the opposing surface during the transfer operation.

8. A fender according to claim 1, wherein the engagement part comprises a roller, wherein the roller is rotatably connected to the mount by the coupling, and the regulating part regulates its rotational speed for regulating the velocity of movement of the engagement part over the opposing surface.

9. A fender according to claim 8, wherein the regulating part comprises a rotary damper.

10. A fender according to claim 8, wherein the engagement part further comprises a second roller, wherein the second roller is rotatably connected to the mount by the coupling, and the regulating part regulates its rotational speed for regulating the velocity of movement of the engagement part over the opposing surface.

11. A fender according to claim 1, wherein the engagement part forms a concave engagement interface to the opposing surface.

12. A fender according to claim 11, wherein, when the engagement part comprises first and second rollers, and the rollers are supported by the coupling in a concave V-configuration for engaging with a curved opposing surface.

13. A fender according to claim 1, wherein the engagement part is for engagement with a monopile foundation.

14. A method for transferring a body between a vessel and an offshore structure in a transfer operation, the method comprising the steps of:
providing a marine fender for engaging the offshore structure during the transfer operation, the fender being fixed to the vessel by a mount:
forcing the vessel and the structure together to engage an engagement part of the fender with an opposing surface of the offshore structure such that interface friction resists movement of the engagement part over the opposing surface;
regulating the velocity of movement of the engagement part over the opposing surface using a regulating part of a coupling connecting the engagement part to the mount; and
transferring the body between the vessel and the offshore structure.

15. A method according to claim 14, wherein the step of regulating the velocity comprises limiting the amplitude of forces applied through the vessel to the opposing surface to less than the static friction between the engagement part and the opposing surface during the transfer operation.

16. A marine vessel, comprising:
a mount;
a fender fixed to the mount for engaging an offshore structure during a transfer operation, the fender comprising:
an engagement part for engaging with an opposing surface of the offshore structure when the vessel and opposing surface are forced together such that interface friction resists movement of the engagement part over the opposing surface; and
a coupling connecting the engagement part to the mount, wherein the coupling comprises a regulating part for regulating the velocity of movement of the engagement part over the opposing surface.
